(19) United States
(12) Patent Application Publication
(10) Pub. No.: US 2025/0221441 A1
(43) Pub. Date: Jul. 10, 2025

(54) PRE-IMPACTOR DEVICE AND METHODS THEREOF

(71) Applicant: University of Georgia Research Foundation, Inc., Athens, GA (US)

(72) Inventors: Robert Benjamin Davis, Athens, GA (US); Mark Jackson, Athens, GA (US)

(21) Appl. No.: 19/015,113

(22) Filed: Jan. 9, 2025

Related U.S. Application Data
(60) Provisional application No. 63/619,539, filed on Jan. 10, 2024.

(51) Int. Cl. A23N 5/00

(52) U.S. Cl. CPC A23N 5/00

(57) ABSTRACT

Pre-impaction devices and methods of creating imperfections or weaknesses in the outer layer of an object. Pre-impaction devices are used to create imperfections or weaknesses in an object's outer layer such that removal of the outer layer does not damage items on the interior of the object.

### TECHNICAL FIELD

This disclosure relates to products and methods of pre-impacting various objects.

### BACKGROUND

A problem in tree nut processing is that during the cracking and shelling procedure, kernels are damaged while they are extracted from the shells. During current cracking and shelling procedures, kernels of various nuts are often damaged and broken.

There exists a need for an improved cracking and shelling procedure that minimizes damage to kernels.

### SUMMARY

It is to be understood that this summary is not an extensive overview of the disclosure. This summary is exemplary and not restrictive and it is intended to neither identify key or critical elements of the disclosure nor delineate the scope thereof. The sole purpose of this summary is to explain and exemplify certain concepts of the disclosure as an introduction to the following complete and extensive detailed description.

The present disclosure relates to a pre-impaction device for pre-impacting objects. Such device includes a body. The body can be substantially the same shape as the object to be pre-impacted. The body can additionally be substantially square-shaped or rectangular-shaped. The body additionally includes a length, a width, and a height. The length of the body may range from about 20 mm up to about 100 mm. The width of the body may range from about 5 mm up to about 70 mm. The body may additionally be made of steel, steel alloys, stainless steel, stainless steel alloys, brass, iron, and the like.

The present disclosure relates to a recess disposed within the body of the device. The recess includes a recess surface. The recess can be substantially the same shape as the object to be pre-impacted.

The present disclosure relates to ridges disposed within the recess and coupled to the surface of the recess. Ridges include ridge ends disposed at either end of the ridge. Such ridge ends may form projections. Projections may range in length from about 1 mm up to about 10 mm. Various ridges including various projection lengths may be used in a device. Ridges may be substantially triangular where the ridge is wider closer to the surface of the recess and narrower at further away from the recess surface. The ridge may form an edge at the position further away from the recess surface.

The present disclosure relates to devices including two or more ridges. Such devices may include at least one ridge disposed along a longitudinal axis of the device and at least one ridge disposed along a latitudinal axis of the device. Ridges may also be oriented at an angle to either a longitudinal or latitudinal axis of the device.

The present disclosure relates to methods of pre-impacting objects. Such methods create imperfections (e.g., “scoring”) or weaknesses into an outer layer of the object. Creations of imperfections or weaknesses allows for the outer layer to then be more easily removed where cracks, separations, or ruptures in the outer layer emanate from the imperfections or weaknesses in a controlled or predictable manner. Controlling from where cracks, separations, or ruptures will begin and how they will propagate allows for easy removal and prevents damage to an internal structure of the pre-impacted object. As a non-limiting example, pre-impacting a pecan may allow for its shell to be removed without damaging the kernel within the pecan shell.

The present disclosure relates to methods of pre-impacting objects by providing a pre-impaction device, disposing an object above or adjacent to the pre-impaction device, and pressing the object into the device. Selective pressures may be applied during pressing. As a non-limiting example, a large pressure can be applied to introduce full imperfections in an outer layer of an object. Larger pressures may also be required when an object's outer layer is harder than other objects' outer layers. As a non-limiting example, a small pressure may be applied to introduce incomplete imperfections, including but not limited to imperfections only along a portion of where an object was pressed into a ridge, or weaknesses into an object's outer layer. As a non-limiting example, asymmetrical pressures may be applied to produce unique patterns of imperfections or weaknesses on an object to produce selective rupture points.

The present disclosure relates to methods of pre-impacting objects where the object is placed between two pre-impaction devices. The two devices can then be pressed together to pre-impact the object.

The present disclosure relates to industrial applications. Such applications may use one or more machines where objects are continuously fed into the machines. The machines include configurations of pre-impaction devices that pre-impact the object once it is fed into the machine. The pre-impacted object is then removed from the machine. As a non-limiting example, this could be used to rapidly pre-impact pecans for commercial uses.

The present disclosure relates to a variety of objects capable of being pre-impacted. As a non-limiting example, objects may include nuts. As a non-limiting example, nuts may include tree nuts. As a non-limiting example, tree nuts may include almonds, macadamia nuts, Brazil nuts, hazelnuts, pecans, cashews, pine nuts, pistachio nuts, walnuts, and the like.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIGS. 1A-1D depict an example pre-impacting device according to the present disclosure. FIG. 1A displays a diagonal, isometric view from above such device FIG. 1B displays a direct view from above such a device. FIG. 1C displays a side view of such a device with dashed lines indicating the device's internal structure. FIG. 1D displays an end view of such a device with dashed lines indicating the device's internal structure.

FIGS. 2A-2D depict an example pre-impacting device according to the present disclosure. FIG. 2A displays a diagonal, isometric view from above such device FIG. 2B displays a direct view from above such a device. FIG. 2C displays a side view of such a device with dashed lines indicating the device's internal structure. FIG. 2D displays an end view of such a device with dashed lines indicating the device's internal structure.

FIGS. 3A-3D depict an example pre-impacting device according to the present disclosure. FIG. 3A displays a diagonal, isometric view from above such device FIG. 3B displays a direct view from above such a device. FIG. 3C displays a side view of such a device with dashed lines indicating the device's internal structure. FIG. 3D displays an end view of such a device with dashed lines indicating the device's internal structure.

FIG. 4 displays three example pre-impacting devices with circumferential-longitudinal, circumferential, and longitudinal ridges from left to right according to the present disclosure.

FIG. 5 displays examples of methods of loading pre-impactor devices according to aspects of the present disclosure.

FIG. 6 displays a pre-impacting rig according to an aspect of the present disclosure.

FIGS. 7A-B illustrate experimental cracking equipment according to an aspect of the present disclosure, with 7A illustrating a full view of a drop weight rig and FIG. 7B showing the placement of a pecan between two impactors in the drop weight rig.

FIGS. 8A-D are representative photos of pecans falling into each of the four crack categories: (a) under crack, (b) standard crack, (c) ideal crack, and (d) over crack, according to an aspect of the present disclosure.

### DETAILED DESCRIPTION

### I. Definitions

It should be appreciated that this disclosure is not limited to the devices and methods described herein. It is also to be understood that the terminology used herein is for the purpose of describing certain embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any devices, methods and materials similar or equivalent to those described herein can be used in the practice or testing of the present invention. All publications mentioned are incorporated herein by reference in their entirety.

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied. All methods described herein can be performed in any suitable order unless otherwise indicated herein or otherwise clearly contradicted by context. The use of any and all examples, or example language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

### II. Pre-Impacting Device

The present disclosure relates to a device 100 used to pre-impact various objects. Objects include any object with a hard, outer layer that may be removed to access a structure or additional object on the interior of the object. Objects include but are not limited to nuts or legumes, including but not limited to peanuts. Nuts further include but are not limited to tree nuts, such as almonds, macadamia nuts, Brazil nuts, hazelnuts, pecans, cashews, pine nuts, pistachio nuts, walnuts, and more. Objects to be pre-impacted may further include, but are not limited to, for shellfish, crustaceans, seeds, and any other such objects that have a shell protecting an object within the shell's interior. A device 100 pre-impacts an object in order to form imperfections in the outer layer (e.g., the shell of a nut) of the object. These imperfections then allow for the outer layer of the object to be removed without damaging an internal structure of the object, including, but not limited to, a seed, kernel, fruit, meat, pit, or any other such structure residing inside the object.

As a non-limiting example, the device 100 may pre-impact a pecan to introduce imperfections in the pecan shell such that subsequent removal of the pecan shell does not damage the kernel retained within the shell. This is an improvement on existing industrial methods of shell removal that tend to damage the kernel.

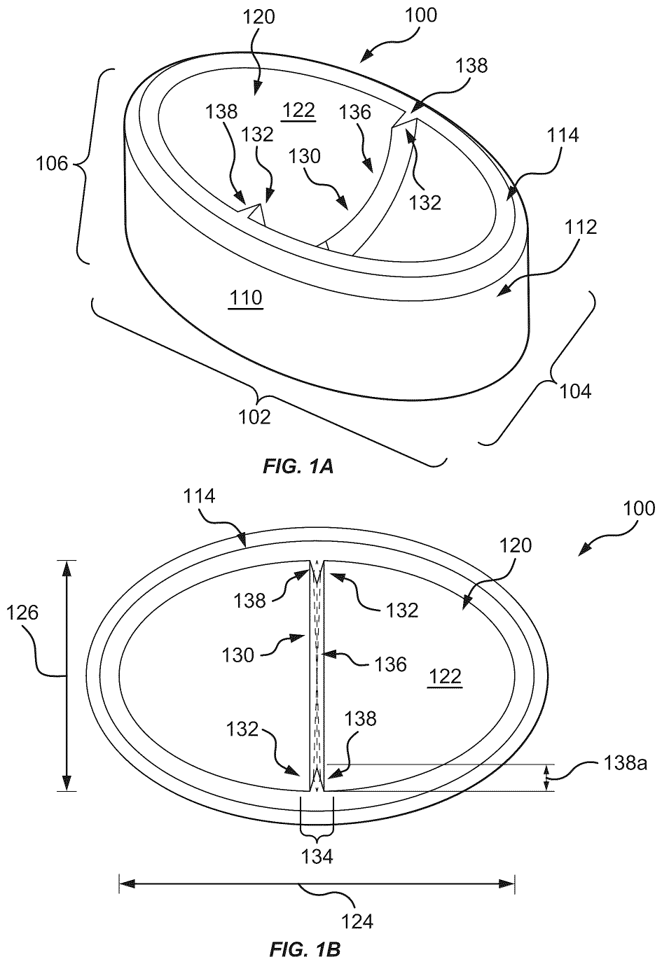

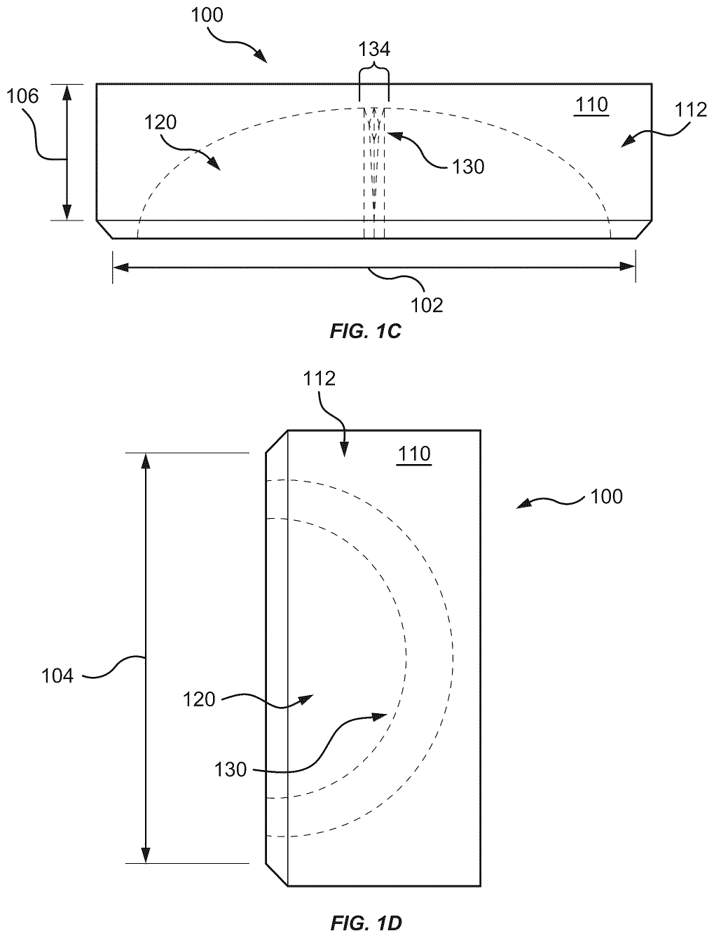

The present disclosure relates to various pre-impacting devices 100. As shown in FIGS. 1A-3D, such devices 100 may be generally shaped to receive an object. The shape of a device 100 may be designed to generally conform to the shape of the object. As a non-limiting example, a device 100 designed to pre-impact nuts, such as a pecan, may be shaped in substantially the same way as the nut (i.e., pecan), as shown in FIGS. 1A-3D for pecans. Devices 100 may also be shaped differently than the object to be pre-impacted. In such examples, a device 100 may have a substantially square or rectangular base, as further described herein. Devices 100 include lengths 102, widths 104, and heights 106.

The present disclosure relates to pre-impacting devices 100 including a body 110. Such body 110 includes an outer surface 112 and may be shaped substantially the same as the object to be pre-impacted, including, but not limited to, ovular-shaped nuts, as shown in FIGS. 1A, 2A, and 3A. The body 110 of a device may additionally be shaped differently than the object to be pre-impacted. As a non-limiting example, a body 110 may be square, rectangular, or the like, as shown in FIGS. 1C, 2C, and 3C. A body 110 of a device further includes a lip 114, as shown in FIG. 1A. A device 100 further include a recess 120 including a recess surface 122 and a length 124 and a width 126. As a non-limiting example, a recess 120 may be shaped substantially the same as the object to be pre-impacted, as further discussed herein. A lip 114 extends from the outer surface 112 of a body 110 to the edge of a recess 120, as shown in FIG. 1A. A lip 114 of a device 100 may be flat, diagonal, or tiered. An example of a tiered lip 114 that protrudes diagonally from a body 110 before leveling out around the edge of a recess 120 is shown in FIGS. 1A, 2A, and 3A. A recess 120 may be generally shaped as to receive the object to be pre-impacted. As a non-limiting example, a device 100 designed to pre-impact a pecan may include a recess 120 generally shaped to receive the outer geometry of a pecan shell. A body 110 of a device 100, not including the recess 120, may be hollow or solid to afford such devices 100 more or less weight, respectively, as desired.

The present disclosure relates to recesses 120 positioned within devices 100. Such recesses 120 further include one or more ridges 130. Ridges 130 include ridge ends 132 and ridge widths 134. Ridges 130 are disposed within recesses 120, as shown in FIG. 1A. Ridges 130 are positioned as to create imperfections in outer layers of objects that are pre-impacted by devices 100. Imperfections created in outer layers of objects serve as rupture points or centers from which cracks, separations, or ruptures emanate once a pre-impacted object is later subjected to pressure. Creating such imperfections allows for controlled, predictable outer layer removal where ruptures are designed to minimize damage to an interior structure of an object. When an object is pressed into the recess 120 of a device 100, ridges 130 will press against the outer layer of the object to create said imperfections. Ridges 130 may be designed as to maximize contact between a ridge 130 and an outer layer of an object being pre-impacted. As a non-limiting example, ridges 130 may all be of the same height to maximize such contact. In additional, non-limiting examples, ridges 130 that are taller at central locations of a recess 120 (i.e., closer to the center of a recess 120 than to its edges) are capable of being used.

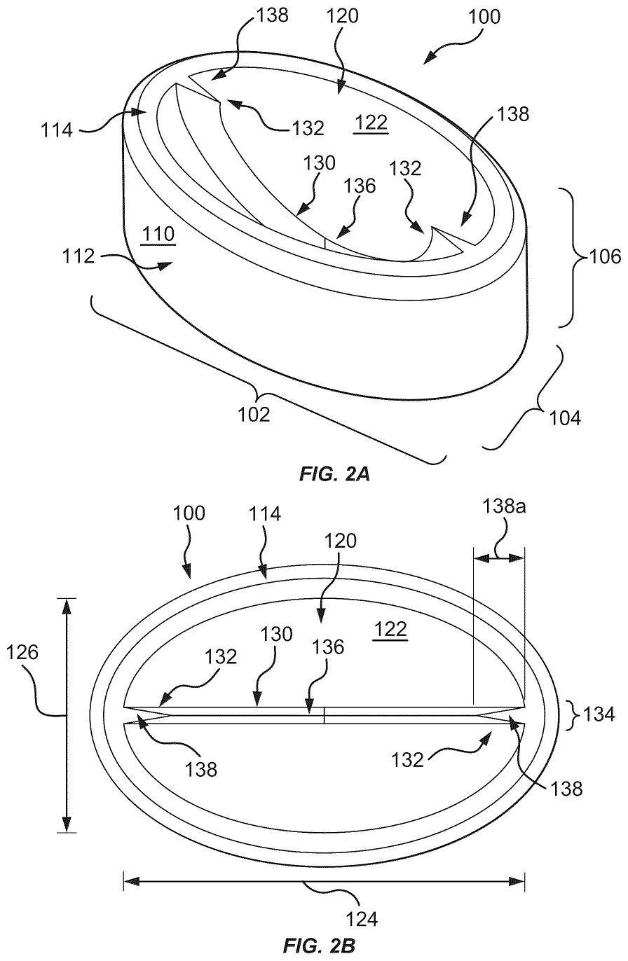

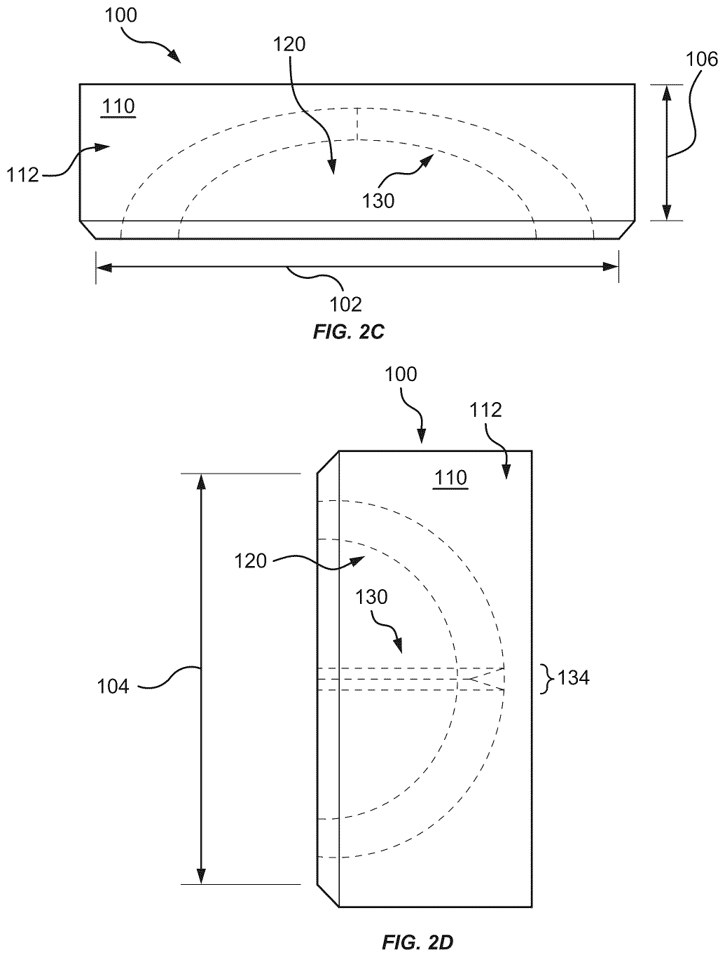

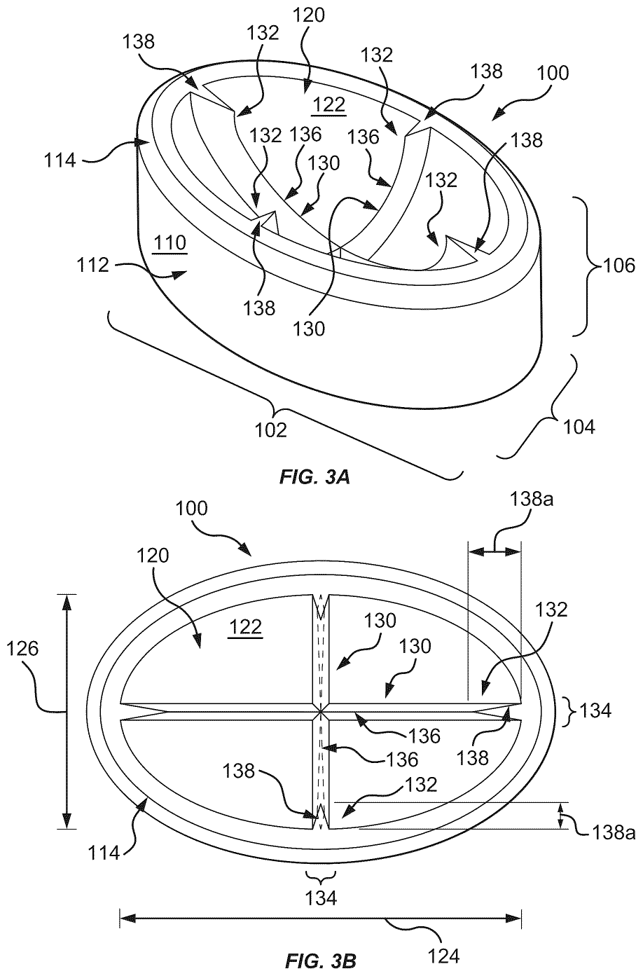

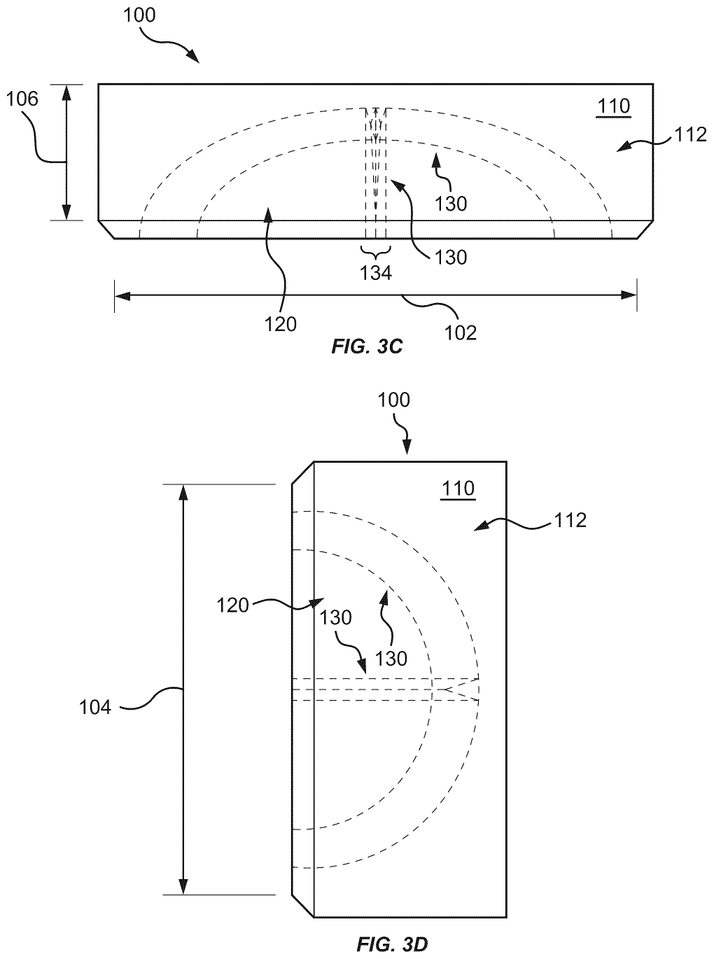

As non-limiting examples, ridges 130 can be positioned within a recess 120 in a wide variety of manners, as shown in FIGS. 1A, 2A, and 3A. A device 100 may include a single ridge 130 extending across a latitudinal axis of a device 100, as shown in FIG. 1A. A device 100 may include a single ridge 130 extending across a longitudinal axis of a device 100, as shown in FIG. 2A. A device 100 may include more than one ridge 130 positioned within a recess 120, as shown in FIG. 3A. Such a device 100 may include ridges 130 disposed along both longitudinal and latitudinal axes of the device 100, as shown in FIG. 3A. Other devices 100 may include more than two ridges 130, including but not limited to three, four, five, six, seven, or more ridges. Though the ridges 130 in FIGS. 1A, 2A, and 3A are positioned at approximately half the length or width of a device 100, ridges 130 may be positioned at any longitudinal or latitudinal axis in the recess 120 of a device 100. Such positions allow for asymmetrical imperfections to be formed in the outer layer of an object being pre-impacted. Ridges 130 may also be disposed at various angles within the recess 120 of a device 100 including various diagonal angles. As such, the present disclosure relates to any number of ridges 130 disposed at any angle within the recess 120 of a device 100.

As a non-limiting example, ridges 130 may include a variety of shapes. As shown in FIGS. 1A, 1B, 2A, 2B, 3A, and 3B, ridges may be blade-like, though other profiles may be desired. Blade-like shapes include shapes that are narrow and triangular that are wider at the recess surface 122 and come to an edge 136 at a point further away from the recess surface 122. Blade-like shapes may increase the ability to introduce imperfections or weaknesses, such as scoring, an object being pre-impacted. By reducing the area of contact (e.g., blade edge), the pressure placed on an object may be enhanced at a given force, as understood by one of skill in the art. In examples using blade-like shapes for ridges 130, it may be advantageous to subject such ridges 130 to hardening procedures. Hardening blade-like ridges 130 prevents such ridges 130 from being bent or otherwise damaged during use. Any hardening procedure known in the art 130 may be used including but not limited to work hardening, annealing, carburizing, tempering, nitriding, and the like. In additional, non-limiting examples, ridges with rounded or blunt, including but not limited to substantially square-like, profiles may be used depending on a desired application. In such examples, hardening processes may also be used to prevent damage to non-blade-like ridges 130.

Ridges 130 may include projections 138 that extend away from a lip 114 of the device 100 into and above a recess 120, as shown in FIGS. 1A, 1B, 2A, 2B, 3A, and 3B. Projections may appear triangular when viewed from above, as shown in FIGS. 1B, 2B, and 3B, though other profiles are also capable of use. Projections 138 include lengths 138a, as shown in FIGS. 1B, 2B, and 3B. As a non-limiting example, projection lengths 138a may range from about 1 mm up to about 10 mm. Projection lengths may also range from about 2 mm up to about 9 mm, about 3 mm up to about 8 mm, about 4 mm up to about 7 mm, and about 5 mm up to about 6 mm. As a non-limiting example, a device 100 including more than one ridge 130 may include various projections 138 of varying lengths 138a within the same device 100, as shown in FIG. 3B.

The present disclosure relates to devices 100 of a variety of materials. Devices 100 may comprise steel, steel alloys, stainless steel, stainless steel alloys, brass, iron, titanium, and various other metals, hardened polymers, hardened woods, hardened composites, and any additional materials comprising sufficient strength to not deform during pre-impacting methods disclosed herein.

The present disclosure relates to devices 100 of a variety of sizes. The length 102, width 104, and height 106 of an example device should be sufficient to allow for a recess 120 that will fit the outer layer of an object during pre-impaction. As a non-limiting example, FIGS. 1A-3D display devices 100 configured to pre-impact pecans. Such example devices include lengths 102 of about 65 mm up to about 75 mm and widths 104 of about 40 mm up to about 50 mm, as shown in FIGS. 1C-1D. In additional, non-limiting examples, lengths 102 may range from about 20 mm up to about 100 mm, about 30 mm up to about 90 mm, about 40 mm up to about 80 mm, or about 50 mm up to about 70 mm. In additional, non-limiting examples, widths 104 may range from about 5 mm up to about 70 mm, about 15 mm up to about 65 mm, about 25 mm up to about 55 mm, or about 35 mm up to about 45 mm. As a non-limiting example, a height 106 of a device 100 may be about 15 mm up to about 25 mm, as shown in FIG. 1C. In additional, non-limiting examples, a height 106 of a device 100 may be about 5 mm up to about 35 mm, about 10 mm up to about 30 mm, and about 20 mm up to about 25 mm.

The present disclosure relates to devices 100 including recesses 120 with a recess length 124 and a recess width 126. Recess lengths 124 may range from about 50 mm up to about 70 mm. Lengths 124 may further include ranges from about 30 mm up to about 90 mm and about 40 mm up to about 80 mm. Recess widths 126 may range from about 30 mm up to about 40 mm. Recess widths 126 may also range from about 5 mm up to about 60 mm, about 10 mm up to about 55 mm, about 15 mm up to about 45 mm, about 20 mm up to about 35 mm, and about 25 mm up to about 30 mm.

### III. Pre-Impacting Methods

The present disclosure relates to various methods of creating and using the device 100 described herein. The present disclosure relates to methods of pre-impacting objects, including, but not limited to, nuts. Pre-impaction methods introduce imperfections in outer layers, such as shells, of objects that facilitate easier removal of the outer layer. Imperfections can be selectively made within the outer layer of an object by pre-impaction to control crack formation in the outer layer during outer layer removal. As such, pre-impacting provides strategically tailored cracking of outer layers to remove such outer layers without damaging the interior of the object.

The present disclosure relates to a method of removing an outer layer from an object. In such method, the object is first disposed above or received within the recess 120 of a device 100. The object is so disposed or received such that at least one or more portions of the object are adjacent to the ridges 130 disposed within the recess 120. Pressure is then applied to push the outer layer into the ridges 130. Pressures of varying amounts may be applied depending on the application. As a non-limiting example, an object with a harder outer shell may require more pressure to be applied than an object with a softer outer shell. The application of pressure against the object that is adjacent to the ridges 130 creates imperfections within the outer shell of the object. Such imperfections will substantially correspond to the ridges 130.

As a non-limiting example, an object pressed against the device shown in FIG. 3A would have two imperfection lines (such as “scores”) with one extending along the objects central longitudinal axis and another extending along the object's central latitudinal axis. This can be referred to as “scoring” an object. Imperfections may not perfectly match the pattern of the ridges 130, such as with a lower applied force. Following the creation of one or more imperfections, the outer layer is removed. As a non-limiting example, the outer layer may then be removed by an impact to the object to rupture its outer layer. Such impact may be applied by longitudinal or circumferential force, as shown in FIG. 5. A longitudinal force may be applied by striking, hitting, squeezing, or otherwise applying a force to an object on its ends. A circumferential force may be applied by striking, hitting, squeezing, or otherwise applying a force to an object around a latitudinal circumference of the object.

As a non-limiting example, it may be desired to only weaken an outer layer, instead of fully creating imperfections, such as when an object is fragile. In such an example, less pressure would be applied. The outer layer of the object would then be removed. Whether weakening an outer layer, creating partial imperfections, or creating full imperfections (such as complete score lines along an object where it came into contact with ridge(s) 130), pre-impacting an object allows for controlled rupture of an outer layer of the object upon the application of additional pressure. In such an example, an object having undergone pre-impacting can then undergo an additional force or pressure. Such additional force or pressure will cause cracks, separations, or ruptures of an outer layer of the object emanating from weaknesses or partial or full imperfections. This allows for controlled rupturing or cracking of an outer layer of a pre-impacted object to prevent damage to an interior structure of the object.

As a non-limiting example, pressure may be asymmetrically applied to an object resting on ridges 130 of a device 100. That is, a higher pressure may be applied to one end or specific area of a device 100 while less pressure or no pressure is applied to other ends or areas of the device 100. Asymmetrical loading may be caused by using machinery that can asymmetrically load one end of a device 100. Such loading may additionally be achieved by positioning a device 100 under a machine such that the machine is only disposed over a portion, such as an end, of the device 100. In such an example, the machine, when applying force, will only apply force to one portion of the device creating an asymmetrical pressure or force. Asymmetrical pressure loading allows the creation of unique imperfection patterns and resulting rupture points. Such loading may be used with objects having unique shapes where specific rupture points are desired. Asymmetrical pressure may be applied by any number of devices, machines, or the like disclosed herein for pressure application. Asymmetrical pressure can also be applied after pre-impaction in the outer layer removal process. As a non-limiting example, prior to an impact used for shell removal, an initial asymmetrical pressure may be applied via impact or continuous pressure application to concentrate stress in a portion of the outer layer of an object. The concentrated stress will cause that portion of the outer layer to rupture first during outer layer removal.

As non-limiting examples, a wide number of devices, machines, or the like can be used to press an object against ridge(s) 130 of a device 100. As a non-limiting example, a human hand could press the object. As a further, non-limiting example, another surface, such as a surface of a piece of metal, could be disposed above the object and pressed into it, thus pressing the object into the ridges 130. As a further, non-limiting example, a second device 100 may be disposed above an object resting on a first device 100. Either or both of the two devices 100 could then be pressed as to form imperfections in the object. In such examples, the use of two devices 100 allows for imperfections (such as score marks) or weaknesses to be introduced on both sides of an object being pre-impacted. As a non-limiting example, two devices 100 can introduce a score line all the way around a circumference of an object being pre-impacted. In such examples, introducing imperfections or weaknesses on both sides of an object may allow for enhanced ease of outer layer removal.

In examples of industrial applications, a machine press can be used to press an object into ridges 130 of one or more device(s) 100. In such examples, industrial applications can be designed so that a large number of objects can be pre-impacted in a repeatable, fast manner. Such industrial examples allow for the large number of objects to be pre-impacted such that subsequent outer layer removal does not damage the item within the object. As a non-limiting example, an industrial application for shelling pecans would include a pre-impaction stage. In the pre-impaction stage, pecans can be lined up and fed into the pre-impactor, such as on a conveyor belt. Once a pecan has been fed into the pre-impactor and is, as a non-limiting example, sandwiched between two pre-impaction devices, a machine can then strike or otherwise apply pressure to pre-impact the pecan. In such an example, the machine may strike an exterior surface of one or both pre-impaction devices being used to sandwich the pecan. Subsequent shell removal would then be less damaging to the kernel within the pre-impacted pecan than would be a shell removal process without pre-impaction. As such, a product to be sold, such as pre-shelled pecans, would be of a higher quality to consumers. As discussed herein, the aforementioned industrial application is not limited to pre-impaction of pecans. Such application may be applied to any object including a hard outer layer that is removed before consumption of an item on the interior of the object. Such objects include additional nuts, legumes, shellfish, and the like.

As a non-limiting example, a tree nut, such as an almond, pecan, Brazil nut, or other such tree nuts, can be pre-impacted by devices 100 disclosed herein. This allows tailoring of specific crack types that are preferred for shell removal by first introducing selective imperfections. In the example of a tree nut, a tree nut is pre-impacted with a specific geometry to strategically introduce imperfections in the shell corresponding to the device's geometry, as described herein. The nut is then placed under pressure so that the shell of the nut will rupture at the locations of the introduced imperfections. Such controlled rupturing prevents the kernel, fruit, and the like of a tree nut from being damaged during shelling.

### EXAMPLES AND TEST RESULTS

### Example 1

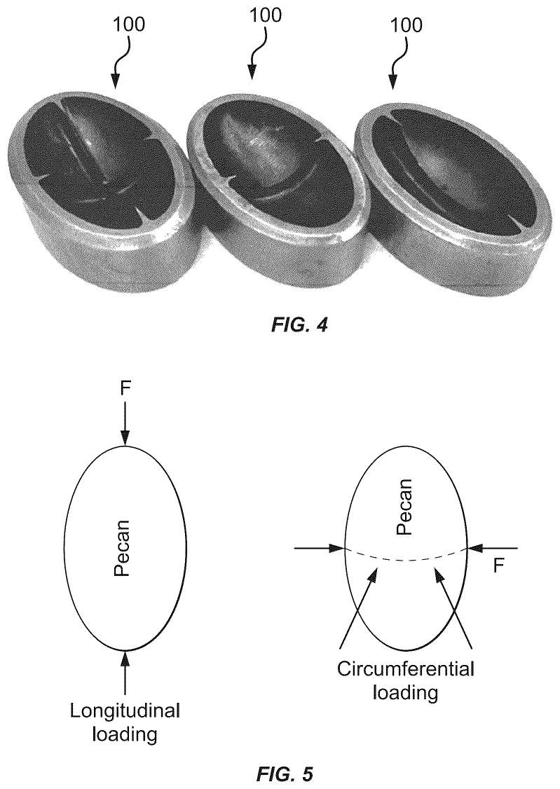

Devices were manufactured to crack pecans in a way that produced imperfections allowing for easier shell removal, as shown in FIG. 4. In one embodiment of the present invention, heat treated steel was machined to produce a half-ellipsoid cut out with blades protruding outward. The ellipsoid shape and blades were created with a computer numerical control (CNC) machine. Pre-impaction devices were then annealed at 500° F. and oil quenched. The resultant devices had a hardness of 45-50 Rockwell. This hardness ensured durability of the blades.

The devices shown in FIGS. 1A, 2A, and 3A were each used to crack a number of pecans. Results suggested that pecans that were cracked using a device containing ridges running in more than one direction, such as the device in FIG. 3A, produced the most easily shelled pecans after pre-impaction. These pecans were able to be shelled while producing the least damage to the kernel inside of the pecan shell.

### Example 2

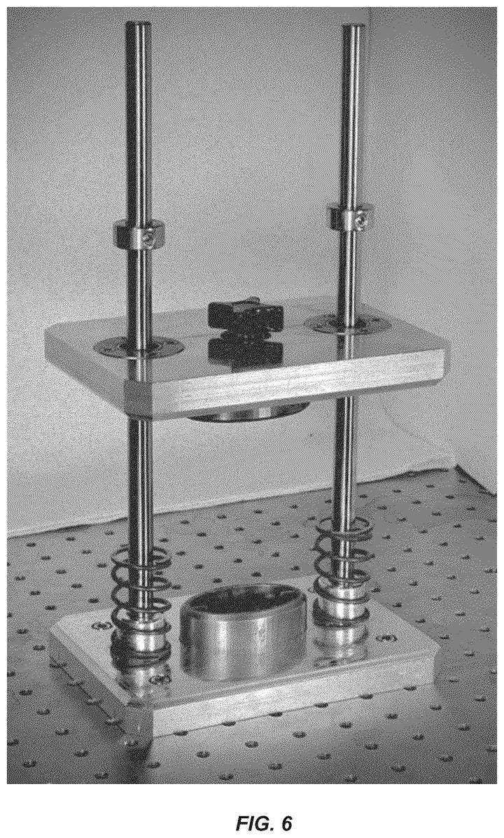

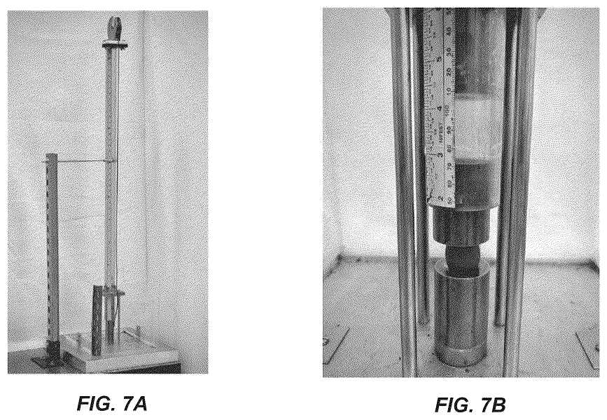

A second experimental study was conducted to demonstrate the effect of pre-impacting on the shelling of pecans. For this study, a total of 135 pecans of the McMillan variety are used. Equipment was used to pre-impact (FIGS. 4 and 6) and crack (FIGS. 7A-B) the pecans. Of the 135 pecans, 45 pecans are cracked without pre-impacting to serve as a baseline case, 45 pecans are pre-impacted with circumferential pre-impactors and subsequently cracked, and finally, 45 pecans are pre-impacted with longitudinal pre-impactors and subsequently cracked. Prior to cracking, all pecans are conditioned in a hot water bath for 70 minutes which has been found to correspond to an average kernel moisture content of 8%.

When the pecans are pre-impacted, the top plate of the pre-impacting rig is raised to 10 (cm) and dropped on one pecan at a time. After the pecans are pre-impacted, they are cracked in the drop weight rig and the drop weight is dropped from 43.9-64.5 (cm) corresponding with an energy range of 5.7-9.8 (J).

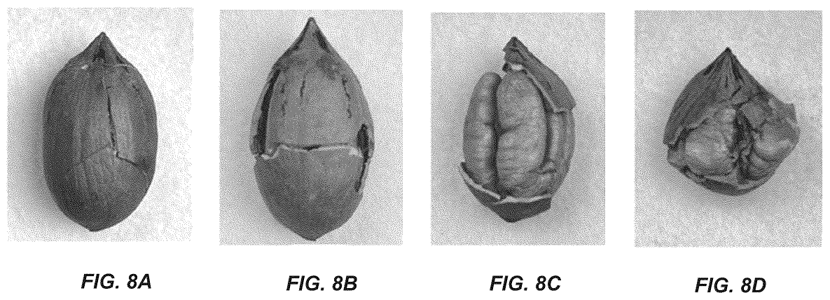

To assess the efficacy of pre-impacting, the pecans are analyzed after they are cracked and categorized based on how easily the shell may be removed. The four categories are: under crack, standard crack, ideal crack, and over crack. FIGS. 8A-8D show examples of cracked pecans that would fall into each category. For under cracked pecans, the shell is mostly intact and difficult to remove as shown in FIG. 8A. Conversely, over cracked pecans exhibit visible kernel damage after cracking (see FIG. 8D).

Standard cracks and ideal cracks are both desirable, however there is a distinction between the two. Ideal cracks extend around the entire circumference of the pecan. Complete circumferential cracks are preferred, as it is easy to pull apart the two halves of the shell without damaging the kernels. In some cases, the shell is completely shattered and falls away from the kernel. A crack around the complete circumference of a pecan is only considered ideal if the circumferential crack is in the middle 50% of the pecan's length. An example of an ideally cracked pecan is shown in FIG. 8C.

Pecans with standard cracks have some of their circumference cracked, but not completely. These cracks are distinguished from under cracked pecans in that at least 40% of the circumference is cracked in the middle 50% of the pecan's length. However, they must propagate around less than 100% of the pecans circumference to distinguish them from ideal cracks. A representative photo of a standard crack is shown in FIG. 8B.

The distribution of crack classifications assigned to pre-impacted pecans is compared to a baseline case. In the data, two pre-impactor geometries are considered. The first being circumferential pre-impactors, and the second is longitudinal pre-impactors. Table 1 shows the percentage of pecans resulting in a desired crack classification (standard cracks and ideal cracks). All pecans (100%) that are first pre-impacted with the circumferential pre-impactors resulted in desirable cracks. The longitudinal pre-impactors also produce a larger percentage of desirable crack types (87%) relative to baseline (73%). These results suggest that pecans that are pre-impacted are more likely to be cracked in a manner that results in easier shell removal.

TABLE 1
Number and percentage of cracked pecans that resulted
in a desirable classification (standard or ideal) when
cracked in the energy range of 5.7-9.8 (J). Three pre-
impact cases are compared: baseline (no pre-impact),
pre-impact with a circumferential pre-impactor,
and pre-impact with a longitudinal pre-impactor.

| | Desirable crack types | |
|---|---|---|
| | (“standard” or “ideal”) | |
| | Number | Percentage |
| Baseline (N = 45) | 33 | 73% |
| Circumferential pre-impact | 45 | 100% |
| (N = 45) | | |
| Longitudinal pre-impact | 39 | 87% |
| (N = 45) | | |

Although several aspects have been disclosed in the foregoing specification, it is understood by those skilled in the art that many modifications and other aspects will come to mind to which this disclosure pertains, having the benefit of the teaching presented in the foregoing description and associated drawings. It is thus understood that the disclosure is not limited to the specific aspects disclosed hereinabove, and that many modifications and other aspects are intended to be included within the scope of any claims that can recite the disclosed subject matter.

It should be emphasized that the above-described aspects are merely possible examples of implementations, merely set forth for a clear understanding of the principles of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A pre-impaction device, the device comprising:
a. a body of the device;
b. a recess disposed within the body of the device, wherein the recess comprises a surface and is substantially the same shape as an object to be pre-impacted; and
c. one or more ridges disposed within the recess and coupled to the surface of the recess.

2. The device of claim 1, wherein the body is substantially the same shape as the object to be pre-impacted.

3. The device of claim 1, wherein the body is substantially square-shaped or rectangular-shaped.

4. The device of claim 1, wherein the body comprises a length, wherein the length ranges from about 20 mm up to about 100 mm.

5. The device of claim 1, wherein the body comprises a width, wherein the width ranges from about 5 mm up to about 70 mm.

6. The device of claim 1, wherein the body comprises a material, and wherein the material comprises steel, steel alloys, stainless steel, stainless steel alloys, brass, and iron.

7. The device of claim 1, wherein the one or more ridges are substantially triangular, wherein the ridge is wider at a first position adjacent to the surface of the recess and narrower at a second position further away from the surface of the recess compared to the first position, and wherein the ridge forms an edge at the second position.

8. The device of claim 1, wherein the device comprises two or more ridges, wherein at least one of the two or more ridges is disposed along a longitudinal axis of the device, and wherein at least one of the two or more ridges is disposed along a latitudinal axis of the device.

9. The device of claim 1, wherein the one or more ridges comprises a ridge oriented at an angle to either a longitudinal or latitudinal axis of the device.

10. The device of claim 1, wherein each of the one or more ridges comprises two ridge ends, wherein each ridge end forms a projection disposed at each ridge end.

11. The device of claim 10, wherein the projection includes a length, and wherein the length of the projection ranges from about 1 mm up to about 10 mm.

12. The device of claim 11, wherein the device comprises two or more ridges, wherein at least one ridge includes a pair of ridge ends of one length, and wherein at least a second ridge includes a second pair of ridge ends of a second length.

13. A method of pre-impacting objects, the method comprising:
a. providing a pre-impaction device;
b. disposing an object to be pre-impacted above or adjacent to the pre-impaction device, wherein the object includes an outer layer; and
c. applying a selected pressure to cause the pre-impaction device to pre-impact the object.

14. The method of claim 13, wherein pre-impacting the object introduces imperfections or weaknesses into the outer layer of the object, wherein the outer layer of the object is then capable of being removed without causing damage to an internal structure of the object.

15. The method of claim 13, wherein the pre-impaction device comprises:
a. a body of the device;
b. a recess disposed within the body of the device, wherein the recess comprises a surface and is substantially the same shape as an object to be pre-impacted; and
c. one or more ridges disposed within the recess and coupled to the surface of the recess.

16. The method of claim 13, wherein the method includes a second pre-impaction device, wherein the object to be pre-impacted is placed between the two pre-impaction devices, and wherein the two pre-impaction devices are then pressed together to pre-impact the object.

17. The method of claim 13, wherein pressure is applied by a machine in an industrial setting, wherein a number of objects are continuously fed into the pre-impaction device, wherein the number of objects are individually pre-impacted, and wherein the number of objects are then removed from the pre-impaction device.

18. The method of claim 13, wherein the selected pressure is selected according to the desired outcome, wherein a large pressure is applied to introduce imperfections, wherein a small pressure is applied to introduce incomplete imperfections or weaknesses, and wherein an asymmetrical pressure is applied to produce unique patterns of imperfections or weaknesses on an object.

19. The method of claim 13, wherein unique patterns of imperfections or weaknesses create a selected rupture point in the outer layer of the object.

20. The method of claim 13, wherein the object to be pre-impacted comprises one or more nuts.
